(19) United States
(12) Patent Application Publication
(10) Pub. No.: US 2009/0248503 A1
(43) Pub. Date: Oct. 1, 2009

(54) SYSTEMS, METHODS AND COMPUTER PRODUCTS FOR A PERSONAL PORTABLE ADVERTISING AND MESSAGING AGENT

(75) Inventors: Carl H. Fisher, Aurora, OH (US); Rick A. Hamilton, II, Charlottesville, VA (US); Robert M. Parmer, Springdale, AR (US); James E. Seaman, Falls Church, VA (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/054,791

(22) Filed: Mar. 25, 2008

(51) Int. Cl. G06Q 30/00

(52) U.S. Cl. 705/14

(57) ABSTRACT

Transmitting targeted advertisements over a communications network to consumers using a plurality of programmable transmitting and receiving devices is accomplished by initiating the programmable transmitting and receiving devices and prompting an advertisement content user to provide and populate the memory of the programmable transmitting and receiving devices with categories, parameters, restrictions and requirements of goods and services to be advertised to consumers and then enabling the programmable transmitting and receiving devices to transmit and receive broadcast advertisements. A portion of the transmission enabled transmitting and receiving devices are placed in proximity to goods and services which are advertised and a portion of receiving enabled transmitting and receiving devices are carried by consumers who when in the proximity of the advertised goods and services, receive advertisements via the receiving enabled device.

### TRADEMARKS

IBM® is a registered trademark of the International Business Machines Corporation, Armonk, N.Y., U.S.A. Other names used herein may be trademarks and registered trademarks, or trade or product names of International Business Machines Corporation or other companies.

### TECHNICAL FIELD

This invention relates generally to wireless, as well as wired networked computer system administration and management, software services, application solutions and data replication management directed to data handling programs, such as event monitoring in software management applications, data mining, pattern recognition, data analysis, data transcoding and data conversion operating in various operating system environments, as well as implementations in hardware. More particularly, this invention relates to wireless, as well as wired Internet based advertising and on-line purchasing of consumer goods and services. This invention can be applied to any system running any service provider application and/or operating system.

### BACKGROUND

The sales of personal consumer goods to other consumers make up a large and growing part of everyday commercial interactions, as evidenced by the success of Internet sites such as eBay and Craig's List. Additionally, when driving down any street in suburbia, one is likely to see vehicles and homes with for sale signs posted on them. In addition, yard sale signs advertise a common way of selling a wide variety of items directly from another individual, rather than a company.

Internet based sales methods, can reach large audiences; however, Internet based sales methods inherently come with concomitant short falls, such as requiring that the Internet consumers must sort through many listings for a given desired item in locations not easily accessible to the consumer (across the state, country, or even world). Another shortfall is in the area of trust, where it is not possible to meet the seller, or inspect the items which are for sale ahead of time, the whole basis of the sale requires the consumer/purchaser to trust the seller. This point alone keeps many potential consumers/purchasers from using Internet methods for such personal consumption. Another Internet sales inhibitor is associated with the requirement to register, learn, and repeatedly monitor additional Internet sales oriented sites, which may serve as a deterrent, thus keeping large numbers of potential consumers away. Finally, another inhibiting element associated with these existing social sales networks is the fact that it is very time consuming for the interested purchaser to learn and search the variety of sales oriented sites and opportunities.

Therefore, a need exists for an easy to use and proximity based Internet personal consumer sales system and method. In addition the need exists for personal consumer, as well as, business targeted sales advertising through a portable, context and proximity based advertising agent.

### SUMMARY OF THE INVENTION

A method and system of transmitting and/or broadcasting, by a programmable transmitting and receiving device, targeted advertisements over a communications network using a plurality of programmable transmitting and receiving devices is accomplished by initiating the programmable transmitting and receiving device by a provider/supplier/seller/and/or advertisement content user or by a consumer user. The programmable transmitting and receiving device may be initiated manually via an input device or initiated programmatically and automatically over the communications network via code upload and/or download capabilities. The plurality of programmable transmitting and receiving devices use a general purpose computer processor executing computer executable program code which causes the general purpose computer processor in each of the plurality of programmable transmitting and receiving devices to one of transmit and receive and broker advertising information of goods and/or services and/or mutual needs and interests of sellers and buyers over the communications network. The provider/supplier/seller/and/or advertisement content user is prompted automatically, by the programmable transmitting and receiving device over the communications network, to provide categories of consumer advertisements selected by the provider/supplier/seller/and/or advertisement content user. The categories may include any one or more of the following descriptions: vehicle for sale, dwelling for sale, dwelling for rent, yard sale, personal ads including single and looking to meet someone, personal and business services for sale including photography, plumbing, handyman, light hauling, moving and storage automotive repair, heating and cooling sales and service, computer sales and service, hobby supplies for sale, toy trains bought and sold, care, grooming and sale of exotic and domestic pets, sales and service of communications devices, sales of travel packages, auctions, food and beverage sales, health facility sales and memberships, entertainment and sporting event ticketing reservations and sales. The provider/supplier/seller/and/or advertisement content user is further automatically prompted by the programmable transmitting and receiving device to provide sales specifics, including sales prices and terms and conditions and contact information for obtaining advertised products, goods and/or services. The provider/supplier/seller/and/or advertisement content user is further automatically prompted to provide presence information independently set for each sale and/or service category, mutual interest and need, wherein presence information independently set includes at least one or more of the following conditions: always transmit advertisement, month of the year to transmit advertisement, days of the week to transmit advertisement, time of the day to transmit advertisement, and the geographic location in which to transmit advertisement. Providing these categories of consumer advertisements, sales specifics and presence information independently set conditions includes the following sub operations of populating a dynamic repository with data representing categories of consumer advertisements, sales specifics and presence information independently set and with additional user transmission and/or receiving parameters and/or restrictions and/or requirements including at least two of transmit advertisement only during June and July, yard sales conducted Saturday and Sunday, do not transmit advertisement during dates and times user does not want to be disturbed, do not transmit advertisement during dates and times user is away on travel, do not transmit advertisement when user is more than 100 miles from home, and also the sub operation of storing automatically, in the dynamic repository of the plurality of programmable transmitting and receiving devices, categories of consumer advertisements, sales specifics and presence information independently set and with additional user transmission and/or receiving parameters and/or restrictions and/or requirements and additional user transmission and/or receiving parameters and/or restrictions and/or requirements for transmission and/or broadcasts. A first group of the plurality of programmable transmitting and receiving devices is enabled to transmit advertisements. A second group of the plurality of programmable transmitting and receiving devices is enabled to receive advertisements. The enabling process is accomplished programmatically, thus providing programmatic control and management capabilities to the provider/supplier/seller/and/or advertisement content user of the first group of the plurality of programmable transmitting and receiving devices to transmit, advertisements. In addition, the process of enabling and/or providing the second group of the plurality of programmable transmitting and receiving devices to receive can be accomplished by either the provider/supplier/seller/and/or advertisement content user or the purchaser/buyer/consumer user. Therefore, one or more programmable transmitting and receiving device/devices of the second group of the plurality of programmable transmitting and receiving devices is/are enabled to receive advertisements provided and/or directed to one or more consumers. The enabling/providing transmitting and receiving device may be accomplished programmatically and automatically over the communications network via code upload and/or download capabilities. A portion of the transmission enabled transmitting and receiving devices are placed at sites in proximity to items, products, goods and/or services which are advertised, and a portion of the receiving enabled transmitting and receiving devices are carried by consumers who when near the sites in the proximity of the advertised items, products, goods and/or services, receive advertisements via their receiving enabled device. The advertisements received by the consumer users are transmitted in real time over the communications network to one or more consumer users using one or more of the programmable transmitting and receiving devices from the second group of the plurality of programmable transmitting and receiving devices. In addition, the receiving enabled programmable transmitting and receiving devices can be initiated and enabled by the consumer user, where the consumer user is automatically prompted, by the programmable transmitting and receiving device from the second group of the programmable transmitting and receiving devices, to provide and populate the memory of the programmable transmitting and receiving devices with categories, parameters, restrictions and/or requirements of goods and services the consumer user wants to receive information about. Thus, the programmatic control and management, by either the provider/supplier/seller/and/or advertisement content user, and/or either the consumer user of the at least one programmable transmitting and receiving device includes management and control of the general purpose computer processor device including general purpose computer processor devices consisting of a personal digital assistant (PDA), a pager, a cellular phone and a smart cellular phone, such as a palm pilot and a Blackberry, a laptop computer, a computer workstation, a computer server, a radio frequency transceiver and a global positioning system (GPS) receiver. The general purpose computer processor device supports multiple communication protocols, including one or more of short message service (SMS), instant messaging (IM) service, transmission control protocol/Internet protocol (TCP/IP), and an industrial specification and/or protocol for wireless mobile personal area networks, such as Bluetooth. Also, the programmable transmitting and receiving device includes a transceiver which is programmable through software and at least one of a wireless technology interface (WIFI) including an antenna and a universal serial bus (USB) interface, and the communications network is one or more of a local area network including an intranet or extranet and a wide area network including an Internet communications network.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

FIG. 1 illustrates operations of a transmitting and receiving targeted advertisements method 70.

FIG. 2 illustrates a transmitting and receiving targeted advertisements system 20 by which the operations of the method illustrated in FIG. 1 are implemented.

### DETAILED DESCRIPTION

The disclosed exemplary embodiments are intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote limitations of quantity, but rather denote the presence of one or more of the referenced item(s).

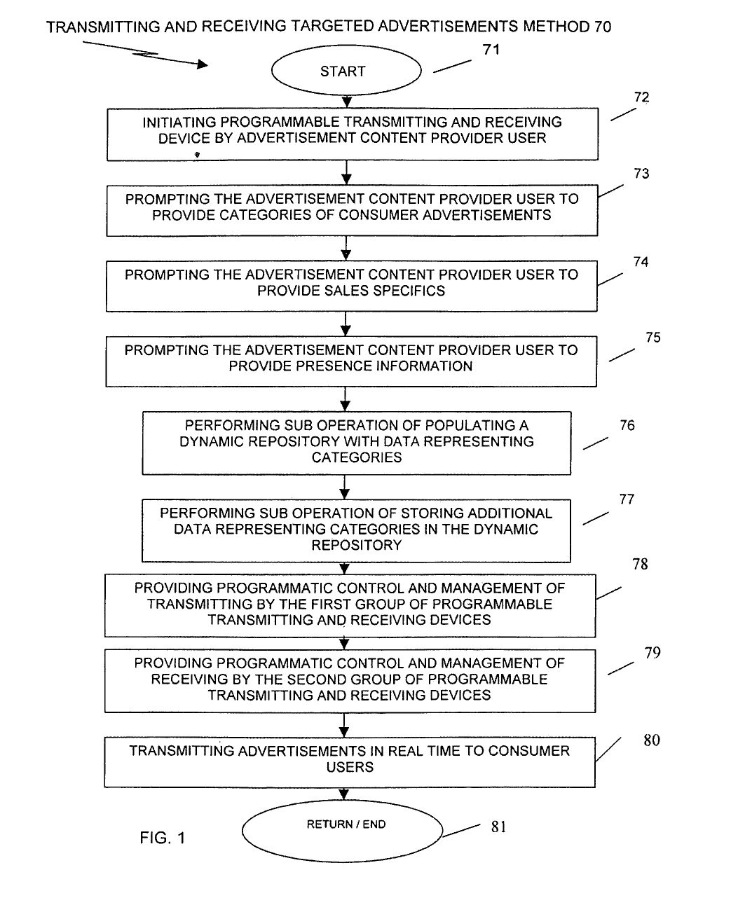

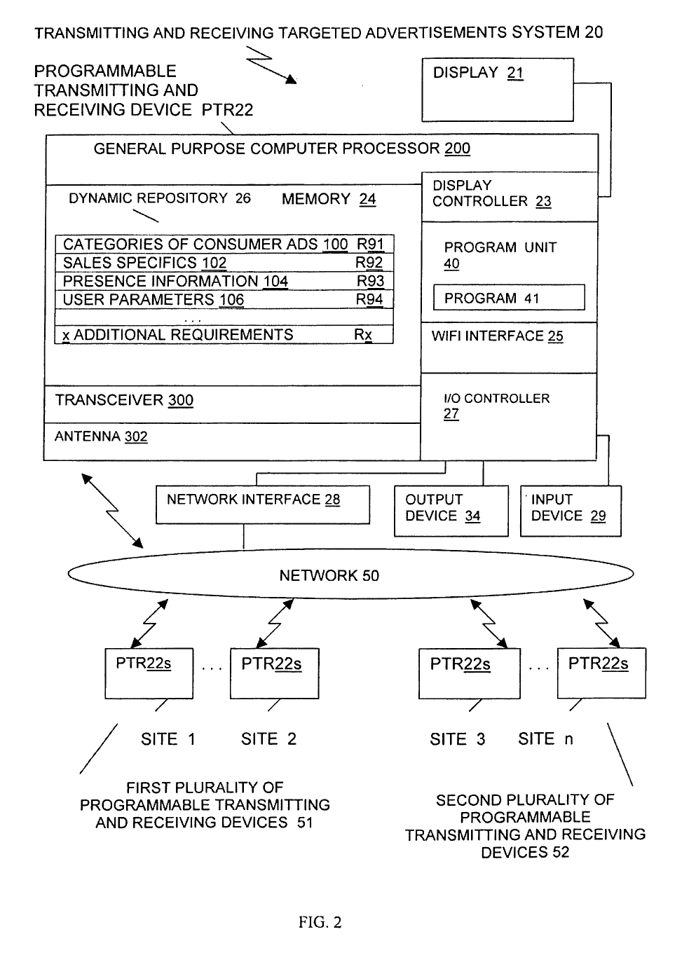

A transmitting and receiving targeted advertisements method 70 (herein referred to as “method 70”) and a transmitting and receiving targeted advertisements system 20 (herein referred to as “system 20”) using a general purpose computer processor executing computer executable program code that causes the general purpose computer processor to perform the operations of method 70 are illustrated in FIGS. 1 and 2 respectively.

Referring to FIG. 2, system 20 includes a programmable transmitting and receiving device PTR22, which contains a general purpose computer processor 200. Residing in the general purpose computer processor 200 is a memory 24. A dynamic repository 26 resides in the memory 24 and the repository 26 contains a plurality of repository entry locations R91, R92, R93, R94 and up to Rx, which hold and/or store a plurality of categories of consumer ads 100 (held in repository entry location R91), sales specifics 102 (held in repository entry location R92), presence information 104 (held in repository entry location R93), user parameters 106 (held in repository entry location R94) and up to “x” number of additional requirements (held in up to repository entry location Rx), where the x number of additional requirements is limited by the physical capacity of the memory 24. Also, residing in the general purpose computer processor 200 is a program unit 40 and a program 41, containing the executable program code that cause the general purpose computer processor to carry out the method 70 of operating as a software agent for the purpose of transmitting and receiving appropriate advertisements to targeted consumer users, so the target users can make educated purchasing decisions, and not have to sort through many listings for a given desired item in locations not easily accessible or not being able to see and or try the item, product or good; thereby raising the likelihood for the seller of completing a sale and raising the likelihood of preventing buyer's remorse, after a sale.

The memory 24 can include any one or combinations of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge or cassette). Moreover, the memory 24 may incorporate electronic, magnetic, optical, and/or other types of storage media. Note that the memory 24 can have a distributed architecture, where various components are situated remotely from one another, but can be accessed by the general purpose computer processor 200.

In the exemplary embodiment, the general purpose computer processor 200 includes and/or is connected to a combination of controllers and various interfaces. The combination of controllers may include a display controller 23, and an input/output (I/O) controller 27. The various interfaces may include a wireless technology interface such as a WIFI interlace 25, a network interface 28 and may also include a universal serial bus interface. In addition, the general purpose computer processor 200, residing in the programmable transmitting and receiving device PTR22 may include output devices, such as a display 21 and output device 34, which may include an audio output device. In addition, the general purpose computer processor 200 may include an input device 29, such as a mouse, a keyboard, a microphone or other known input devices.

In the exemplary embodiment, the programmable transmitting and receiving device PTR22 includes a transceiver 300 and an antenna 302 for transmitting and receiving communications signals over the air waves in manners known in the art.

In the exemplary embodiment, the programmable transmitting and receiving device PTR22 may be one of a plurality of programmable transmitting and receiving devices, such as one of a first plurality of programmable transmitting and receiving devices 51 and a second plurality of programmable transmitting and receiving devices 52 (hereafter, interchangeably referred to as programmable transmitting and receiving devices PTR22s), where each programmable transmitting and receiving device in the first and second pluralities of programmable transmitting and receiving devices 51 and 52 respectively contains the memory, controllers, interfaces input and output devices, antenna, transceiver, and program components described as being contained in the programmable transmitting and receiving device PTR22 discussed above.

In the exemplary embodiment, network interface 28 cooperatively couples the general purpose computer processor 200 to a communications network, such as a network 50. The network 50 may be a wired and/or wireless network including a wide area network such as the Internet or a local area network, including an intranet or an extranet. In addition, the programmable transmitting and receiving device PTR22 may be cooperatively coupled to the network 50 through wireless technology interfaces, such as the WIFI interface 25. Furthermore, each programmable transmitting and receiving devices PTR22s of the first and second pluralities of programmable transmitting and receiving devices 51 and 52 may be physically positioned in different site locations, such as site 1, site 2, site 3 up to site n throughout the networked environment.

Referring to FIG. 2, the network interface 28 can be, for example but not limited to, one or more buses (such as the universal serial bus) or other wired or wireless connections, as known in the art. The network interface 28 may have additional elements, which are omitted for simplicity, such as controllers, buffers (caches), drivers, repeaters, and receivers, to enable communications. Further, the network interface 28 may include address, control, and/or data connections to enable appropriate communications among the aforementioned components.

Referring to FIG. 1 and FIG. 2, at the operation start 71, of the method 70, the system 20 receives a signal from a provider, supplier or seller/user of advertisement content from an input device, such as described by the input device 29 including, but not limited to, a mouse or keyboard, which activates the program 41, where method 70 is stored as executable program code on a computer executable medium in program unit 40. Upon activation, the program 41 performs other selections in method 70 from selection signals received from the input device 29, causing the program 41 to be executed by the general purpose computer processor 200 to operate as a software agent in performing the operations of method 70 of transmitting and/or broadcasting, by a programmable transmitting and receiving device, such as the programmable transmitting and receiving device PTR22, targeted advertisements over a communications network, such as the network 50, using a plurality of programmable transmitting and receiving devices PTR22s, such as those composing the first and second pluralities of programmable transmitting and receiving devices 51 and 52.

Again referring to FIG. 1 and FIG. 2, at the operation initiating programmable transmitting and receiving device by advertisement content provider user 72, the program 41 executed by the system 20 initiates each of the programmable transmitting and receiving devices PTR22 to either function as a transmitter or a receiver and/or both a transmitter and a receiver. In addition, each programmable transmitting and receiving device(s) PTR22 and/or PTR22s may be initiated manually via an input device, such as input device 29, or initiated programmatically and automatically over the communications network, such as network 50, via code upload and/or download capabilities. Each of the programmable transmitting and receiving devices PTR22s of the plurality of programmable transmitting and receiving devices, as described by the first and second pluralities of programmable transmitting and receiving devices 51 and 52 use a general purpose computer processor, such as the general purpose computer processor 200, executing computer executable program code, such as program 41, which causes the general purpose computer processor in each of the first and second pluralities of programmable transmitting and receiving devices 51 and 52 to either transmit or receive and/or both transmit and receive and broker advertising information of items, products, and goods and/or services and/or mutual needs and interests of sellers and buyers over the communications network, such as the network 50.

Referring to FIG. 1 and FIG. 2, at the operation prompting the advertisement content provider user to provide categories of consumer advertisements 73, the program 41 executed by the system 20, causes the general purpose computer processor 200 to automatically prompt the provider, supplier or seller/user of advertisement content to provide categories of consumer advertisements 100 selected by the provider, supplier or seller/user of advertisement content. The prompting may be manifested through the display 21 or the output device 34, where the prompting may include an audio and/or visual or other physical alert signal, such as a vibration. The categories of consumer advertisements 100 may include any one or more of the following category descriptions: vehicle for sale, dwelling for sale, dwelling for rent, yard sale, personal ads including single and looking to meet someone, personal and business services for sale including photography, plumbing, handyman, light hauling, moving and storage automotive repair, heating and cooling sales and service, computer sales and service, hobby supplies for sale, toy trains bought and sold, care, grooming and sale of exotic and domestic pets, sales and service of communications devices, sales of travel packages, auctions, food and beverage sales, health facility sales and memberships, entertainment and sporting event ticketing reservations and sales.

Referring again to FIG. 1 and FIG. 2, at the operation prompting the advertisement content provider user to provide sales specifics 74, the program 41 executed by the system 20, causes the general purpose computer processor 200 to again automatically prompt the provider, supplier or seller/user of advertisement content to provide sales specifics 102, including sales prices and terms and conditions and contact information for obtaining advertised products, goods and/or services.

Referring to FIG. 1 and FIG. 2, at the operation prompting the advertisement content provider user to provide presence information 75, the program 41 executed by the system 20, causes the general purpose computer processor 200 to once more automatically prompt the provider, supplier or seller/user of advertisement content to provide presence information 104 independently set for each sale and/or service category, mutual interest and need, where the presence information 104 independently set includes at least one or more of the following conditions: always transmit advertisement, month of the year to transmit advertisement, days of the week to transmit advertisement, time of the day to transmit advertisement, and the geographic location in which to transmit advertisement. Providing these categories of consumer advertisements 100, sales specifics 102 and presence information 104 independently set conditions includes the following sub operations:

Referring again to FIG. 1 and FIG. 2, at performing sub operation of populating a dynamic repository with data representing categories 76, the program 41 executed by the system 20, causes the general purpose computer processor 200 to perform the sub operation of populating the dynamic repository 26 with data representing categories of consumer advertisements 100, sales specifics 102 and presence information 104 independently set and with x additional user parameters and/or restrictions and/or requirements including at least two of transmit advertisement only during June and July yard sales conducted Saturday and Sunday, do not transmit advertisement during dates and times user does not want to be disturbed, do not transmit advertisement during dates and times user is away on travel, do not transmit advertisement when user is more than 100 miles from home, where the user may be either the provider user and/or the consumer user.

Referring to FIG. 1 and FIG. 2, at performing sub operation of storing data representing categories in the dynamic repository 77, the program 41 executed by the system 20, causes the general purpose computer processor 200 to perform the sub operation of storing automatically, in the dynamic repository 26 of the programmable transmitting and receiving device PTR22, data representing categories of consumer advertisements 100, sales specifics 102 and presence information 104 independently set, user parameters 106 and x additional user parameters and/or restrictions and/or requirements. Where, storing data representing categories in the dynamic repository 77 may be characterized as being stored in a master programmable transmitting and receiving device PTR22.

In the exemplary embodiment, each additional programmable transmitting and receiving device PTR22 of the first and second pluralities of programmable transmitting and receiving devices 51 and 52 may be characterized as subordinate programmable transmitting and receiving devices PTR22s, and may be physically located at different site locations. Each of these subordinate programmable transmitting and receiving devices PTR22s may be programmed (i.e., the dynamic repository 26 in each of the programmable transmitting and receiving devices PTR22s may be programmed) over the network 50, by the master programmable transmitting and receiving device PTR22 in a manner identical to the master to contain the same categories of consumer advertisements 100, sales specifics 102 and presence information 104 independently set, user parameters 106 and x additional user parameters and/or restrictions and/or requirements as the master.

In the exemplary embodiment, each of the subordinate programmable transmitting and receiving devices PTR22s in the first plurality of programmable transmitting and receiving devices 51 may be physically positioned in different site locations, such as site 1 and site 2, in immediate close proximity to items, products, goods and/or services to be advertised and sold. Where, immediate, close proximity means being on, in or close to the items, products, goods and/or services to be advertised and sold. Furthermore, each of the subordinate programmable transmitting and receiving devices PTR22s in the first plurality of programmable transmitting and receiving devices 51, may be programmed over the network 50 by the master programmable transmitting and receiving device PTR22 to transmit only; where, each of the subordinate programmable transmitting and receiving devices PTR22s in the first plurality of programmable transmitting and receiving devices 51 only transmit broadcast advertisements pertaining to each of the items, products, goods and/or services represented at different site locations, such as site 1 and site 2, and where the transmitted broadcast advertisements include data such as categories of consumer advertisements 100, sales specifics 102 of the various items, products, goods and/or services within the advertised categories of consumer advertisements 100 the presence information 104, as well as being programmed to include presence information independently set and with additional user parameters 106 and/or restrictions and/or requirements and x additional user parameters and/or restrictions and/or requirements for transmission and/or broadcasts.

In the exemplary embodiment, each of the subordinate programmable transmitting and receiving devices PTR22s in the second plurality of programmable transmitting and receiving devices 52 may be programmed either by the master programmable transmitting and receiving device PTR22 or by the targeted advertisement recipient user or users of the programmable transmitting and receiving devices PTR22s to contain some but not all of the identical data representing categories of consumer advertisements 100, sales specifics 102 and presence information 104 independently set, user parameters 106 and x additional user parameters and/or restrictions and/or requirements. For example, the subordinate PTR22s may not contain one or more of the categories of consumer advertisements 100, sales specifics 102 and presence information 104 independently set, user parameters 106 and x additional user parameters and/or restrictions and/or requirements. These subordinate PTR22s may include mobile devices from the group of devices including a personal digital assistant (PDA), a pager, a cellular phone and a smart cellular phone, such as a palm pilot and a Blackberry, a laptop computer, a computer workstation, a computer server, a radio frequency transceiver and/or a global positioning system (GPS) receiver, as well as hard wired stationary devices or devices built into mobile platforms. Each of the subordinate programmable transmitting and receiving devices PTR22s in the second plurality of programmable transmitting and receiving devices 52 may be physically in the possession of a targeted consumer of advertisements who is interested in purchasing items, products, goods and/or services that are being advertised via the programmable transmitting and receiving devices PTR22s of the first plurality of programmable transmitting and receiving devices 51, where the targeted consumer is in the vicinity of or traveling within the proximity of the items, products, goods and/or services and is in receipt, within the range of the programmable transmitting and receiving devices PTR22s of the first plurality of programmable transmitting and receiving devices 51 and may receive via at least one of the programmable transmitting and receiving devices 52, the advertisement data being transmitted by at least one of the programmable transmitting and receiving devices 51, as described further below.

Referring to FIG. 1 and FIG. 2, at the operation enabling transmitting by the first group of programmable transmitting and receiving devices via programmatic control and management 78, the program 41 executed by system 20, causes the general purpose computer processor 200 to perform the operation of enabling, automatically, programmatic control and management of each of the programmable transmitting and receiving device PTR22s in the first group of the plurality of programmable transmitting and receiving devices 51 causing each of the programmable transmitting and receiving device PTR22s in the first group of the plurality of programmable transmitting and receiving devices 51 to transmit advertisements, based on categories of consumer advertisements 100, sales specifics 102, presence information 104, user parameters 106 and x additional requirements.

Again referring to FIG. 1 and FIG. 2, at the operation enabling receiving by the second group of programmable transmitting and receiving devices via programmatic control and management 79, the program 41 executed by system 20, causes the general purpose computer processor 200 to perform the operation of enabling, automatically, programmatic control and management of each of the programmable transmitting and receiving device PTR22s in the second group of the plurality of programmable transmitting and receiving devices 52 causing each of the programmable transmitting and receiving devices 52 to receive advertisements, based on categories of consumer advertisements 100, sales specifics 102, presence information 104, user parameters 106 and x additional requirements.

In the exemplary embodiment, the enabling process is accomplished programmatically, thus providing programmatic control and management capabilities to the provider/supplier/seller/and/or advertisement content user of the first group of the plurality of programmable transmitting and receiving devices to transmit, advertisements. In addition, the process of enabling the second group of the plurality of programmable transmitting and receiving devices to receive can be accomplished by either the provider/supplier/seller and/or advertisement content user or the purchaser/buyer/and/or advertisement content user. Thus, one or more programmable transmitting and receiving device(s) PTR22s of the second group of the plurality of programmable transmitting and receiving devices 52 is/are enabled to receive advertisements provided and/or directed to one or more targeted consumers. The enabling of transmitting and receiving devices may be accomplished programmatically and automatically over the communications network, such as network 50 via code upload and/or download capabilities. The advertisements received by the targeted consumer users are transmitted in real time over the communications network, such as network 50 to one or more consumer users using one or more of the programmable transmitting and receiving devices PTR22s from the second group of the plurality of programmable transmitting and receiving devices 52. In addition, the receiving enabled programmable transmitting and receiving devices PTR22s can be initiated and enabled by the consumer user, where the consumer user is automatically prompted, by the programmable transmitting and receiving device from the second group, i.e., the second plurality of the programmable transmitting and receiving devices 52, to provide and populate the memory of the programmable transmitting and receiving devices with categories of consumer advertisements 100, sales specifics 102, presence information 104, user parameters 106 and x additional requirements related to items, products, and goods and/or services the consumer user wants to receive information about. Thus, the programmatic control and management, by either the provider/supplier/seller/and/or advertisement content user, and/or either the consumer user of the at least one of the programmable transmitting and receiving devices PTR22s includes management and control of the general purpose computer processor device, such as the general purpose computer processor 200, which includes general purpose computer processor devices consisting of a personal digital assistant (PDA), a pager, a cellular phone and a smart cellular phone, such as a palm pilot and a Blackberry, a laptop computer, a computer workstation, a computer server, a radio frequency transceiver and a global positioning system (GPS) receiver. The general purpose computer processor device 200 supports multiple communication protocols, including one or more of short message service (SMS), instant messaging (IM) service, transmission control protocol/Internet protocol (TCP/IP), and an industrial specification and/or protocol for wireless mobile personal area networks, such as Bluetooth. Also, the programmable transmitting and receiving device includes a transceiver which is programmable through software and at least one of a wireless technology interface (WIFI) including an antenna and a universal serial bus (USB) interface, and the communications network is one or more of a local area network including an intranet and a wide area network including an Internet communications network.

Referring to FIG. 1 and FIG. 2, at the operation transmitting advertisements in real time to consumer users 80, the program 41 executed by the system 20, causes the general purpose computer processor 200 to perform the operation of transmitting advertisements, in real time, to the targeted consumer user(s).

Referring to FIG. 1 and FIG. 2, at the operation return/end 81, the program 41 executed by the system 20, causes the general purpose computer processor 200 to cause the method 70 to return to any of the above operations and/or sub operations to continue iteratively processing and performing said operations and/or sub operations for additional transmitting and/or receiving of a plurality advertisements, or the program 41 can direct the method 70 to end.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment(s) disclosed as the best mode contemplated for carrying out this disclosure, but that the disclosure will include all embodiments falling within the scope of the appended claims.

1. A method of transmitting, by an advertisement content provider programmable transmitting and receiving device, targeted advertisements over a communications network to at least a first and second group of a plurality of consumer user programmable transmitting and receiving devices, wherein the plurality of consumer user programmable transmitting and receiving devices use a general purpose computer processor executing computer executable program code which causes the general purpose computer processor in each of the plurality of consumer user programmable transmitting and receiving devices to one of transmit and receive advertising information of goods and services over the communications network, the method comprising:
initiating the advertisement content provider programmable transmitting and receiving device by an advertisement content provider user;
prompting the advertisement content provider user automatically, by the advertisement content provider programmable transmitting and receiving device over the communications network, to provide categories of consumer advertisements selected by the advertisement content provider user,
prompting the advertisement content provider user automatically, by the advertisement content provider programmable transmitting and receiving device to provide sales specifics of categories of consumer advertisements, including sales prices and terms and conditions and contact information for obtaining advertised products, goods and/or services;
prompting the advertisement content provider user automatically, to provide presence information independently set for each sale and service category, interest and need, wherein presence information independently set includes at least one of always transmit advertisement, month of the year to transmit advertisement, days of the week to transmit advertisement, time of the day to transmit advertisement, geographic location in which to transmit advertisement, wherein providing categories of consumer advertisements, sales specifics and presence information independently set flirt her includes the sub operations of:
populating a dynamic repository with data representing categories of consumer advertisements, sales specifics and presence information independently set and additional advertisement content provider user parameters, restrictions and requirements, and
storing automatically, in the dynamic repository of the plurality of consumer user programmable transmitting and receiving devices, data representing categories of consumer advertisements, sales specifics and presence information independently set and additional user transmission parameters, restrictions and requirements,
providing programmatic control and management by the advertisement content provider user of the first group of the plurality of programmable transmitting and receiving devices to transmit, advertisements;
providing programmatic control and management by one of the advertisement content provider user and the consumer user, the second group of the plurality of programmable transmitting and receiving devices to receive, advertisements, wherein an at least one programmable transmitting and receiving device of the second group of the plurality of programmable transmitting and receiving devices is enabled to receive advertisements directed to one or more consumers, wherein the first group of the plurality of programmable transmitting and receiving devices enabled to transmit advertisements are distributed to sites in proximity to a plurality of products, goods and services for sale; and
automatically transmitting advertisements in real time, to one or more consumers having the at least one programmable transmitting and receiving device of the second group of the plurality of programmable transmitting and receiving devices enabled to receive advertisements in proximity to the plurality of products, goods and services for sale,
wherein the first group of the plurality of programmable transmitting and receiving devices is programmed by the advertisement content provider programmable transmitting and receiving device to transmit only broadcast advertisements pertaining to each of the items, products, goods and/or services represented at different site locations, and to transmit the presence information including data such as categories of consumer advertisements, sales specifics of various items, products, goods and/or services within the advertised categories of consumer advertisements,
wherein the second group of the plurality of programmable transmitting and receiving devices is programmed by at least one of the advertisement content provider programmable transmitting and receiving device and targeted advertisement recipient users of the second group of the plurality of programmable transmitting and receiving devices to include a subset of some of identical data representing categories of consumer advertisements, sales specifics and presence information independently set, user parameters and additional user parameters, restrictions and requirements.
